(19) United States
(12) Patent Application Publication
(10) Pub. No.: US 2010/0249354 A1
(43) Pub. Date: Sep. 30, 2010

(54) INJECTION STRETCH BLOW MOLDED ARTICLES AND SYNDIOTACTIC POLYMERS FOR USE THEREIN

(75) Inventors: Luyi Sun, Pearland, TX (US); Mike Musgrave, Houston, TX (US); Tim Coffy, Houston, TX (US)

Correspondence Address: FINA TECHNOLOGY INC, PO BOX 674412, HOUSTON, TX, 77267-4412, US

(73) Assignee: FINA TECHNOLOGY, INC., Houston, TX (US)

(21) Appl. No.: 12/411,684

(22) Filed: Mar. 26, 2009

(51) Int. Cl. C08L 23/12; C08F 110/06; B29C 49/06

(52) U.S. Cl. 526/351; 525/333.7; 264/537

(57) ABSTRACT

Injection stretch blow molded (ISBM) articles and methods of forming the same are described herein. The ISBM articles generally include a syndiotactic propylene-based polymer.

### FIELD

Embodiments of the present invention generally relate to polymers adapted for use in injection stretch blow molding. In particular, embodiments of the invention relate to syndiotactic propylene (sPP)-based polymers adapted for use in injection stretch blow molding.

### BACKGROUND

Attempts have been made to utilize propylene based random copolymers for injection stretch blow molding (ISBM) applications. However, ISBM articles formed from random copolymers can exhibit low clarity in the neck and bottom region of the articles.

Therefore, a need exists for ISBM production processes resulting in ISBM articles having improved clarity in the neck and bottom region while maintaining flexibility and good haptics.

### SUMMARY

Embodiments of the present invention include injection stretch blow molded (ISBM) articles. The ISBM articles generally include a syndiotactic propylene-based polymer.

Embodiments of the invention further include injection stretch blow molded (ISBM) medical and cosmetic packaging and flexible containers that include a syndiotactic propylene-based polymer which exhibits a melt flow rate of from about 1 dg/min to about 30 dg/min., a haze of less than 5%, and a gloss at 45° of greater than 75%.

Embodiments further include methods of forming injection stretch blow molded (ISBM) articles which include providing a syndiotactic propylene-based polymer, injection molding the propylene-based impact copolymer into a preform and stretch-blowing the preform into an article.

### BRIEF DESCRIPTION OF DRAWINGS

FIG. 1 shows the high clarity exhibited by the molded sPP preform compared to the molded comparative resin preform.

FIG. 2 shows the clarity of the molded sPP bottle in relation to the molded comparative resin bottle.

FIG. 3 shows the clarity of the molded sPP bottle in relation to the molded comparative resin bottle at the neck and bottom of the bottle.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other eases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents at the time of filing. Further, unless otherwise specified, all compounds described herein may be substituted or unsubstituted and the listing of compounds includes derivatives thereof.

Various ranges are further recited below. It should be recognized that unless stated otherwise, it is intended that the endpoints are to be interchangeable. Further, any point within that range is contemplated as being disclosed herein.

As used herein, “opaque” means an article is impenetrable to visible light, that is, an opaque object prevents transmission of essentially all visible light. “Transparent” means essentially all visible light passes though the article. The term “semi-opaque” means some, but not all, visible light passes through the article.

In one or more embodiments, the propylene based polymers include stereospecific polymers. As used herein, the term “stereospecific polymer” refers to a polymer having a defined arrangement of molecules in space, such as isotactic and syndiotactic polypropylene, for example. The term “tacticity” refers to the arrangement of pendant groups in a polymer. For example, a polymer is “atactic” when its pendant groups are arranged in a random fashion on both sides of the chain of the polymer. In contrast, a polymer is “isotactic” when all of its pendant groups are arranged on the same side of the chain and “syndiotactic” when its pendant groups alternate on opposite sides of the chain.

In one or more embodiments, the polymers include syndiotactic polypropylene. As used herein, the term “syndiotactic polypropylene” refers to polypropylene having a syndiotacticity measured by ¹³C NMR spectroscopy using racemic pentads (e.g., % rrrr) of greater than at least about 50%, or at least about 55%, or at least about 60%, or at least about 65% or at least about 70%, for example.

In one or more embodiments, the syndiotactic polypropylene may comprise from 0 wt % to 5 wt %, or from 0.1 wt % to 2 wt %, or from 0.2 wt % to 1 wt % ethylene.

The syndiotactic polypropylene may have a melting point (Tₘ) (as measured by DSC) of from about 90° C. to about 138° C., or from about 100° C. to about 136° C. or from about 120° C. to about 135° C., for example. The syndiotactic polypropylene may have a molecular weight (M_{w}) (as measured by gel permeation chromatography) of from about 2,000 to about 1,000,000 or from about 10,000 to about 1,000,000, for example. (See, for example, U.S. Pat. No. 5,476,914 and U.S. Pat. No. 6,184,326, which are incorporated herein by reference.)

As used herein, “haptics” refers to the sensations produced by skin contact with foreign material, such as cloth or plastic. Therefore, “good haptics”, as used herein, refers to the feel of a bottle when held, such as the softness of a bottle.

### Catalyst Systems

Catalyst systems useful for polymerizing olefin monomers include any catalyst system known to one skilled in the art. For example, the catalyst system may include metallocene catalyst systems, single site catalyst systems, Ziegler-Natta catalyst systems or combinations thereof, for example. As is known in the art, the catalysts may be activated for subsequent polymerization and may or may not be associated with a support material. A brief discussion of such catalyst systems is included below, but is in no way intended to limit the scope of the invention to such catalysts.

For example, Ziegler-Natta catalyst systems are generally formed from the combination of a metal component (e.g., a catalyst) with one or more additional components, such as a catalyst support, a cocatalyst and/or one or more electron donors, for example.

Metallocene catalysts may be characterized generally as coordination compounds incorporating one or more cyclopentadienyl (Cp) groups (which may be substituted or unsubstituted, each substitution being the same or different) coordinated with a transition metal through π bonding. The substituent groups on Cp may be linear, branched or cyclic hydrocarbyl radicals, for example. The cyclic hydrocarbyl radicals may further form other contiguous ring structures, including indenyl, azulenyl and fluorenyl groups, for example. These contiguous ring structures may also be substituted or unsubstituted by hydrocarbyl radicals, such as C₁ to C₂₀ hydrocarbyl radicals, for example.

### Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form polymers. The olefin monomers may include C₂ to C₃₀ olefin monomers, or C₂ to C₁₂ olefin monomers (e.g., ethylene, propylene, butene, pentene, methylpentene, hexene, octene and decene), for example. The monomers may include olefinic unsaturated monomers, C₄ to C₁₈ diolefins, conjugated or nonconjugated dienes, polyenes, vinyl monomers and cyclic olefins, for example. Non-limiting examples of other monomers may include norbornene, nobormadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any method known to one skilled in the art, such as via a double-jacketed pipe or heat exchanger, for example.

Alternatively, other types of polymerization processes may be used, such as stirred reactors in series, parallel or combinations thereof, for example. Upon removal from the reactor, the polymer may be passed to a polymer recovery system for further processing, such as addition of additives and/or extrusion, for example.

### Polymer Product

The polymers (and blends thereof) formed via the processes described herein may include, but are not limited to, linear low density polyethylene, elastomers, plastomers, high density polyethylenes, low density polyethylenes, medium density polyethylenes, polypropylene and polypropylene copolymers, for example.

Unless otherwise designated herein, all testing methods are the current methods at the time of filing.

In one or more embodiments, the polymers include propylene based polymers. As used herein, the term “propylene based” is used interchangeably with the terms “propylene polymer” or “polypropylene” and refers to a polymer having at least about 50 wt. %, or at least about 70 wt. %, or at least about 75 wt. %, or at least about 80 wt. %, or at least about 85 wt. % or at least about 99wt. % polypropylene relative to the total weight of polymer, for example.

The propylene based polymers may have a molecular weight distribution (Mₙ/M_{w}) of fiom about 1.5 to about 15, or from about 2 to about 10, for example.

The propylene based polymers may have a melting point (Tₘ) (as measured by DSC) of at least about 90° C., or from about 100° C. to about 138° C., for example.

The propylene based polymers may include about 15 wt. % or less, or about 12 wt. % or less, or about 10 wt. % or less, or about 8 wt. % or less of xylene soluble materials (XS), for example (as measured by ASTM D5492-06).

The propylene based polymers may have a melt flow rate (MFR) (as measured by ASTM D-1238) of from about 0.01 dg/min to about 1000 dg/min., or from about 0.7 dg/min. to about 100 dg/min., for example. The syndiotactic polypropylene polymer may exhibit a melt flow rate of at least about 1 dg./min., or from about 2 dg./min, to about 30 dg./min. or from about 2 dg./min. to about 20 dg./min., for example.

In one embodiment, additives may also be included in the final composition. Nucleators may include any nucleator known to one skilled in the art. For example, non-limiting examples of nucleators may include carboxylic acid salts, including sodium benzoate, talc, phosphates, metallic-silicate hydrates, organic derivatives of dibenzylidene sorbitol, sorbitol acetals, organophosphate salts and combinations thereof. In one embodiment, the nucleators are selected from Amfine Na-11 and Na-21, commercially available from Amfine Chemical, Milliken HPN-68, and Millad 3988, commercially available from Milliken Chemical. Other additives, such as ethylene bis stearamide (EBS), glycerol mono stearate (GMS), may also be included to improve the processability of sPP.

In an embodiment, the additives may be used in concentrations of from about 0 to about 5000 ppm, or from about 5 ppm to about 2000 ppm or from about 10 ppm to about 500 ppm by weight of the polymer, for example.

The additives may contact the polymer by any method known to one skilled in the art. For example, the additives may contact the polymer prior to extrusion (within the polymerization process) or within the extruder, for example. In one embodiment, the additives contact the polymer independently. In another embodiment, the additives are contacted with one another prior to contacting the polymer. In one embodiment, the contact includes blending, such as mechanical blending, for example.

In addition, high density polyethylene (HDPE) and high melt flow rate polypropylene homopolymer could also be blended with sPP to further improve the processability of sPP.

### Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheet, thermoformed sheet, geomembranes and pond liners, for example. Molded articles include single and multi-layered constructions in the form of bottles, tanks, large hollow articles, rigid food containers and toys, for example.

In one or more embodiments, the polymers are utilized in injection stretch blow molding (ISBM) processes to form ISBM articles. The ISBM articles may include thin-walled bottles and other types of containers, for example. The ISBM articles may be formed by any suitable process. For example, ISBM processes may include injecting the polymer into a preform and subsequently stretch-blowing the preform into the desired final form, for example.

In one or more embodiments, the syndiotactic propylene based polymers, as described above, are utilized to form the ISBM articles.

In one or more embodiments, the ISBM articles are medical grade or cosmetic grade articles. In one or more embodiments, the ISBM articles are bottles. Such cosmetic packaging could include products such as viscose lotions, pastes, and drops, for example.

The articles formed from the syndiotactic propylene based polymers exhibit high clarity, article flexibility, and good haptics, in contrast to articles formed from random copolymers, which may have poor clarity in the neck and bottom regions of articles.

In one or more embodiments, the ISBM articles exhibit high clarity. For example, the ISBM articles may exhibit a haze of less than 15%, or less than 10%, or less than 5% (as measured by ASTM D1003).

In one or more embodiments, the ISBM articles exhibit high gloss. For example, the ISBM articles may exhibit a gloss at 450 of greater than 50%, or greater than 65%, or greater than 75% (as measured by ASTM D2457).

### EXAMPLES

The sPP Resin refers to TOTAL Petrochemicals 1751, which is a 20 dg/min. MFR syndiotactic polypropylene commercially available from TOTAL Petrochemicals USA, Inc.

Comparative Resin refers to TOTAL Petrochemicals 7525MZ, which is a propylene based random copolymer having a MFR of 10 dg/min., and which is commercially available from TOTAL Petrochemicals USA, Inc.

The polymer samples were injection stretch blow molded (ISBM) into bottles. The preforms were conditioned at room temperature for at least 24 hours before they were stretch blow molded into bottles on an ADS G62 linear injection stretch blow molder.

The bottles were then tested for optical properties.

The preforms were prepared as follows. The sPP Resin was injection molded into 23 g preforms on the Netstal injection molder under the injection molding conditions listed in Table 1. During the preform injection molding process, it was observed that sPP crystallized faster at a relatively high mold temperature at around 32° C. Compared with the Comparative Resin, the sPP resin required a much longer cooling time to crystallize before the preforms could be ejected. As a result, the cycle time for molding sPP Resin was longer than for the Comparative Resin.

TABLE 1
Preform injection-molding condition.

Resin

| | | Comparative |
|---|---|---|
| | SPP Resin | Resin |
| MFR (g/10 min) | 20 | 10 |
| Preform Weight | 23 g | 23 g |
| Barrel temperature (° C.) | 210 | 250 |
| Hot runner temperature (° C.) | 210 | 250 |
| Mold temperature (static/move) | 32/32 | 10/10 |
| (° C.) | | |
| Injection speed (mm/s) | 5 | 5 |
| Cooling time (s) | 50 | 15 |
| Hold time (s) | 20 | 4 |
| Cycle time (s) | ca. 79.74 | ca. 26.6 |

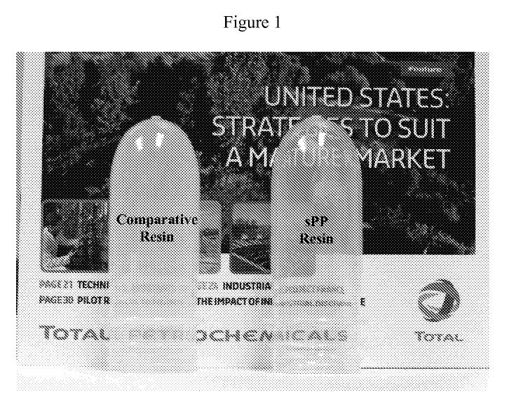

The molded sPP preform exhibited high clarity, as shown in Table 2 and in FIG. 1.

The sPP preforms were injection stretch blow molded (ISBM) into bottles. Similar to the injection molding process, it was observed that sPP required a longer time to crystallize than the Comparative Resin, and the sPP crystallized faster at a relatively higher temperature. Owing to the temperature limit on the cooling water system for blow molding, the mold temperature was set at 16° C., which is the top limit of the chiller.

In order to allow sPP bottles to fully crystallize, the “holding time” during the blowing process was extended to 1.2 seconds, while the Comparative Resin usually requires 0.25-0.50 second holding time. Consequently, the IBSM production rate was reduced to 750 bottle/hour/cavity to accommodate the longer holding time.

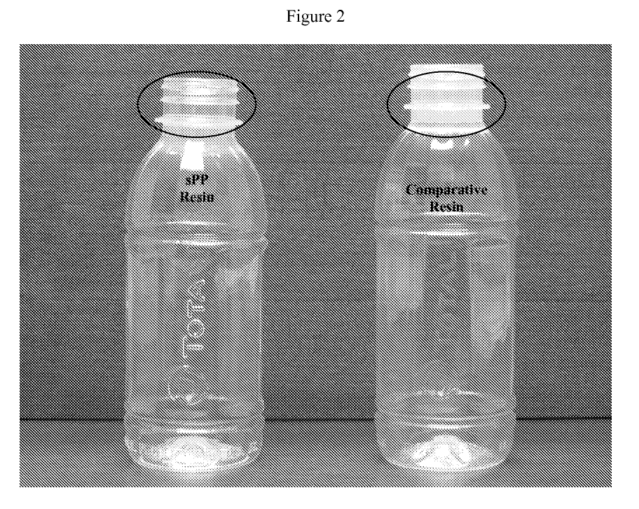

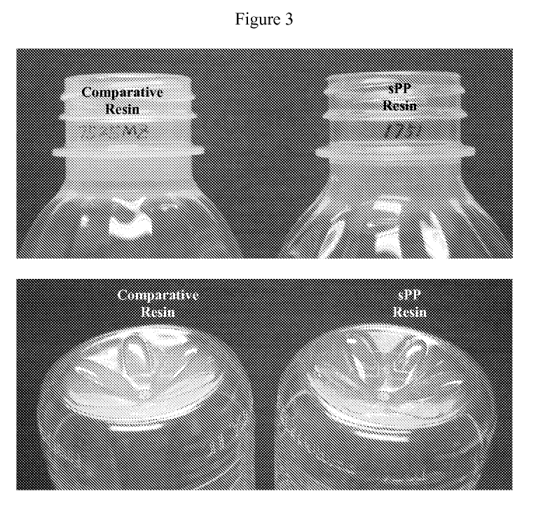

Based on visual inspection, the molded sPP bottles exhibited high clarity on both neck and bottom regions, which appears to be a big advantage over the Comparative Resin bottles. Unfortunately, because of the irregular shape and small size of the neck and bottom regions, the current commercially available instruments for clarity testing are not able to test the gloss and haze values of these two regions. The clarity in the neck and bottom regions can be seen in FIGS. 2 and 3. In addition, the bottle wall of the sPP Resin bottles was very flexible, which may allow for ease of dispensing products by squeezing from ISBM articles or bottles.

TABLE 2
Optical properties of 23 g 1751 bottles.

| Gloss (%) | Haze (%) |
|---|---|
| 76.3 ± 2.8 | 2.7 ± 0.6 |

Note:
the optical properties shown here were measured at bottle sidewall.

While various embodiments have been shown and described, modifications thereof can be made by one skilled in the art without departing from the spirit and teachings of the disclosure. The embodiments described herein are exemplary only, and are not intended to be limiting. Many variations and modifications of the embodiments disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments disclosed herein. The discussion of a reference herein is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. An injection stretch blow molded (ISBM) article comprising: a syndiotactic propylene-based polymer.

2. The ISBM article of claim 1, further comprising a nucleator.

3. The ISBM article of claim 1, wherein the syndiotactic propylene-based polymer exhibits a melt flow rate of from about 1 dg/min. to about 30 dg/min.

4. The ISBM article of claim 1, wherein the article has a haze of less than 10%.

5. The ISBM article of claim 1, wherein the article has a gloss at 45° of greater than 75%.

6. The ISBM article of claim 1, wherein the article is a medical or pharmaceutical packaging container.

7. The ISBM article of claim 1, wherein the article is cosmetic packaging.

8. An injection stretch blow molded (ISBM) package or container comprising:
a syndiotactic propylene-based polymer exhibiting a melt flow rate of from about 1 dg/min to about 30 dg/min.;
a haze of less than 10%; and
a gloss at 45° of greater than 75%,

9. A method of forming an injection stretch blow molded (ISBM) article comprising:
providing a syndiotactic propylene-based polymer;
injection molding the syndiotactic propylene-based polymer into a preform; and
stretch-blowing the preform into an article.

10. The method of claim 9, wherein the article is stretch-blown at a production rate of at least about 500 articles per hour per cavity.

11. The method of claim 10, wherein the article is stretch-blown at a production rate of at least about 750 articles per hour per cavity.

12. The method of claim 9, wherein the syndiotactic propylene-based polymer exhibits a melt flow rate of from about 1 dg/min. to about 30 dg/min.

13. The method of claim 9, wherein the article is selected from the group consisting of medical, pharmaceutical or cosmetic packaging.

14. The method of claim 9, wherein the article has good haptics.
